(19) United States
(12) Patent Application Publication
(10) Pub. No.: US 2009/0081012 A1
(43) Pub. Date: Mar. 26, 2009

(54) System and Method for Securing Lift Gate

(75) Inventors: James T. Hafendorfer, Louisville, KY (US); Shane R. Mikels, Louisville, KY (US)

Correspondence Address: STOLL KEENON OGDEN PLLC, 2000 PNC PLAZA, 500 WEST JEFFERSON STREET, LOUISVILLE, KY, 40202-2828, US

(73) Assignee: JUNGLE JIM'S ACCESSORY PRODUCTS, LLC, Louisville, KY (US)

(21) Appl. No.: 11/859,935

(22) Filed: Sep. 24, 2007

(51) Int. Cl. B65G 69/00; B65G 67/24

(52) U.S. Cl. 414/387; 248/221.11; 414/800

(57) ABSTRACT

A system is provided for securing lift gate including a first rack bracket, a second rack bracket, a first gate bracket, a second gate bracket, a rod bracket and a rod assembly.

A method for securing lift gate includes the steps of grasping a lift gate; applying force to the lift gate sufficient to move the lift gate towards its closed position and, as chamfers of rod ends engage rack brackets, sufficient to compress a spring thereby moving the rod ends and moving a rod assembly within rod holes and thereby allowing the rod ends to align with and insert into the rod slots; In opening the lift gate, applying force to a handle sufficient to compress the spring thereby moving the rod ends and moving the rod assembly within the rod holes and withdrawing the rod ends from the rod slots; and applying force to the lift gate thereby moving the lift gate towards its open position.

### BRIEF DESCRIPTION OF THE DRAWINGS

FIG. 1 is a rear perspective view of the system for securing lift gate according to multiple embodiments and alternatives.

FIG. 2 is a top perspective view of the system for securing lift gate according to multiple embodiments and alternatives.

FIG. 3a is a left side perspective view of the system for securing lift gate showing details of a first rack bracket and according to multiple embodiments and alternatives.

FIG. 3b is a right side perspective view of the system for securing lift gate showing details of a first rack bracket and according to multiple embodiments and alternatives.

FIG. 4a is a right side perspective view of the system for securing lift gate showing details of a second rack bracket and a rod assembly in a closed position and according to multiple embodiments and alternatives.

FIG. 4b is a right side perspective and partially exploded view of the system for securing lift gate, showing details of a second rack bracket and a rod assembly in relation to a tailgate assist device, in an open position and according to multiple embodiments and alternatives.

FIG. 5 is a top perspective view of the system for securing lift gate shown in relation to a tailgate assist device and according to multiple embodiments and alternatives.

FIG. 6 is a top perspective view of the system for securing lift gate in an open position and according to multiple embodiments and alternatives.

FIG. 7 is a top perspective view of the system for securing lift gate in an open position showing details of a rod bracket and according to multiple embodiments and alternatives.

FIG. 8 is a rear view of the system for securing lift gate in an open position showing details of a first rack bracket and according to multiple embodiments and alternatives.

FIG. 9 is a top perspective view of the system for securing lift gate in a closed position showing details of a rod bracket and according to multiple embodiments and alternatives.

FIG. 10 is a rear view of the system for securing lift gate in a closed position showing details of a first rack bracket and according to multiple embodiments and alternatives.

### MULTIPLE EMBODIMENTS AND ALTERNATIVES

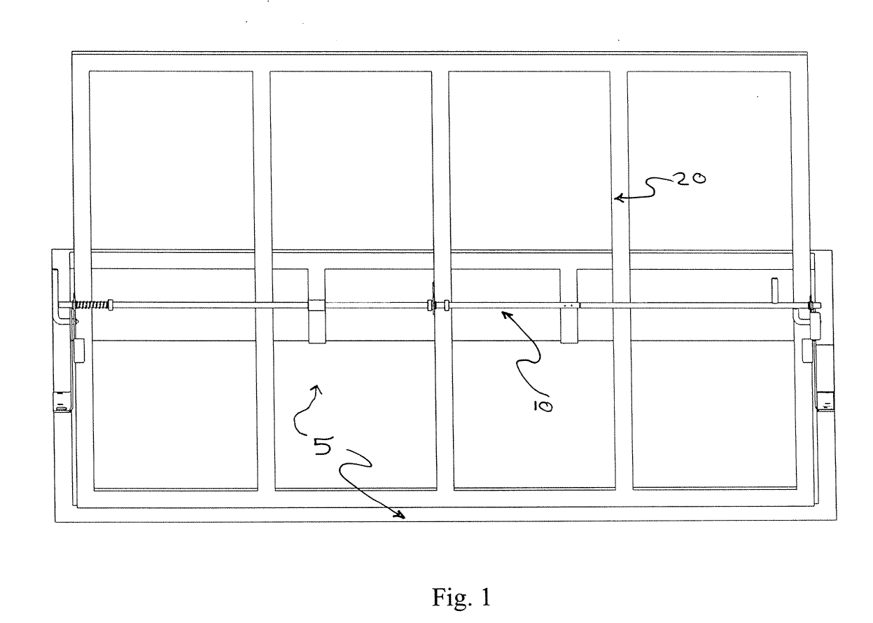

Referring to FIG. 1, a system 10 for securing lift gate 20 is provided. Multiple embodiments and alternatives include the system 10 affixed to a lift gate 20 which is, in turn, affixed to a trailer 5.

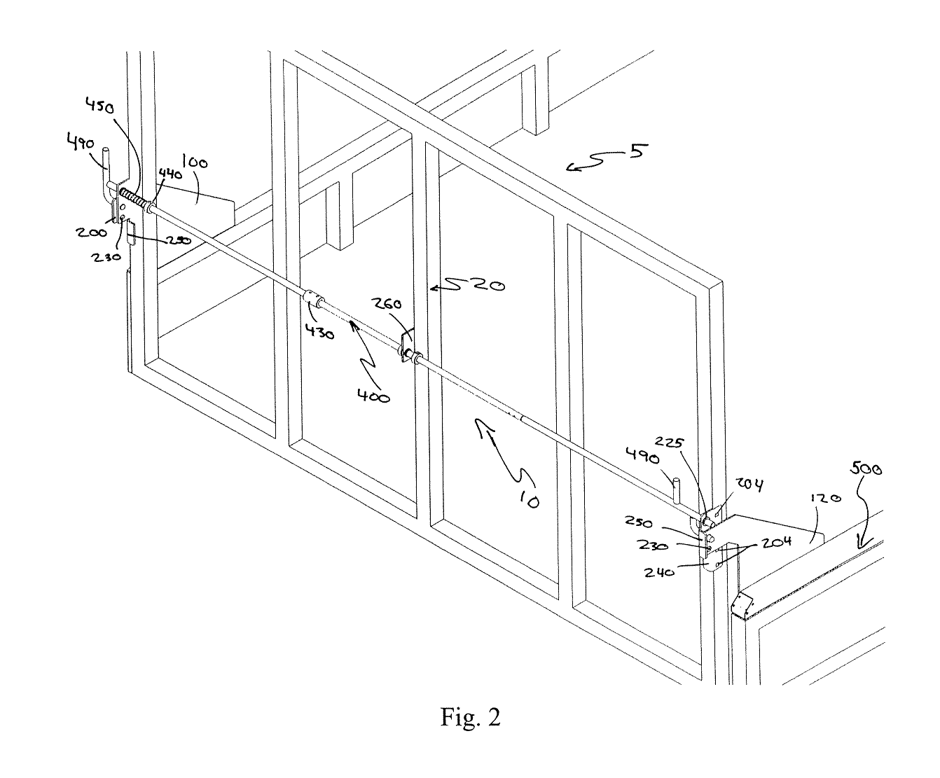

Referring to FIG. 2, the system 10 includes one or more rack brackets such as, for example, a first rack bracket 100 and a second rack bracket 120. The system 10 further includes a first gate bracket 200, a second gate bracket 240, a rod bracket 260, and a rod assembly 400.

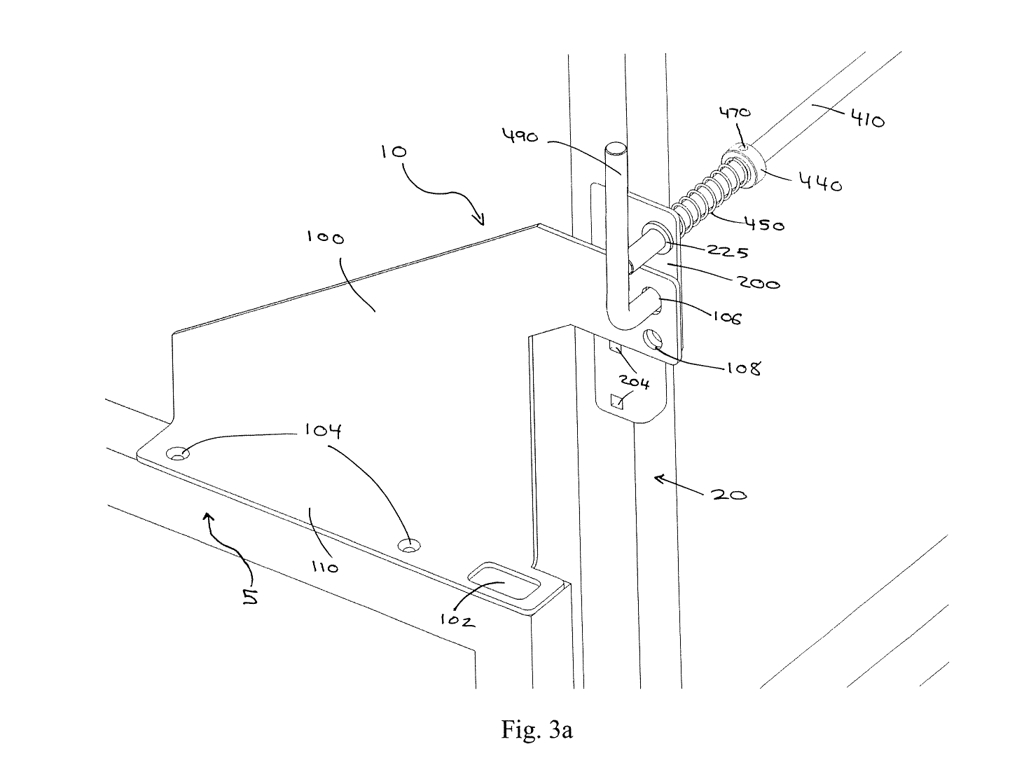

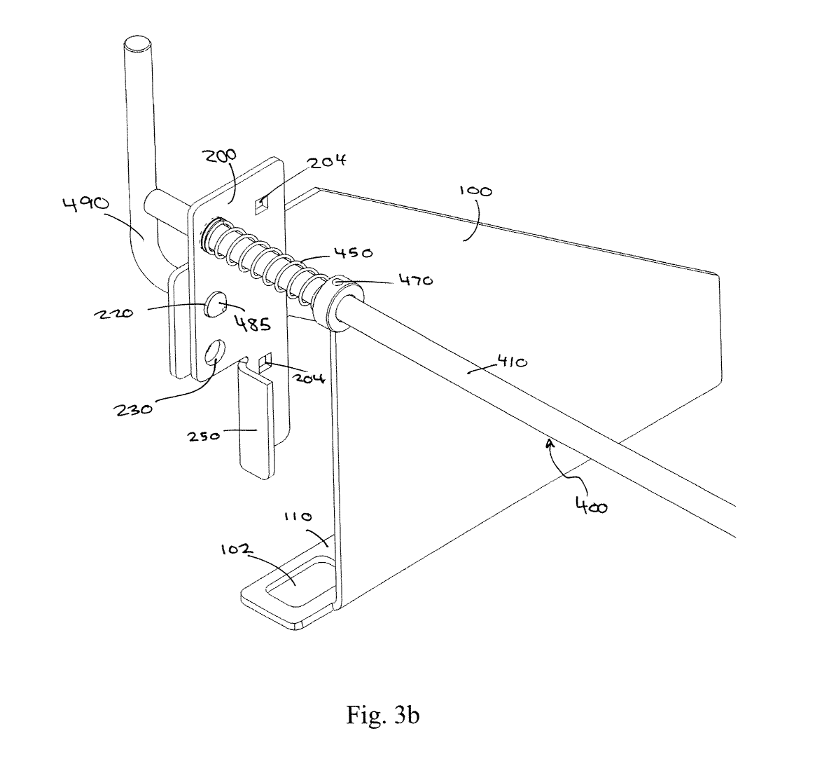

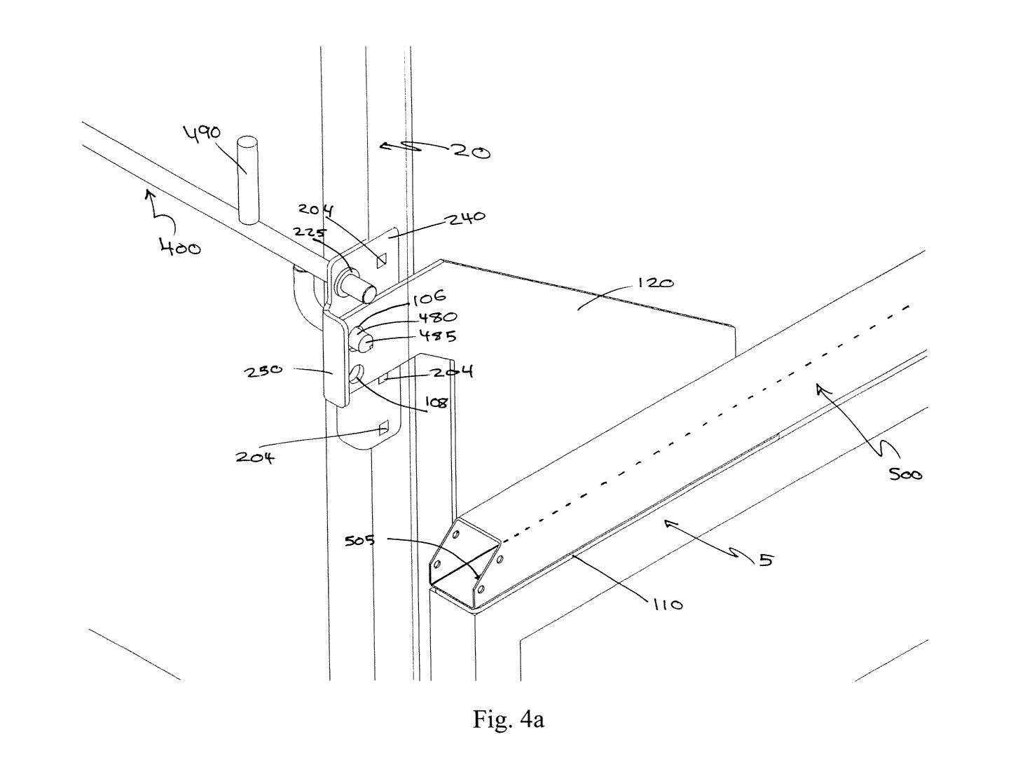

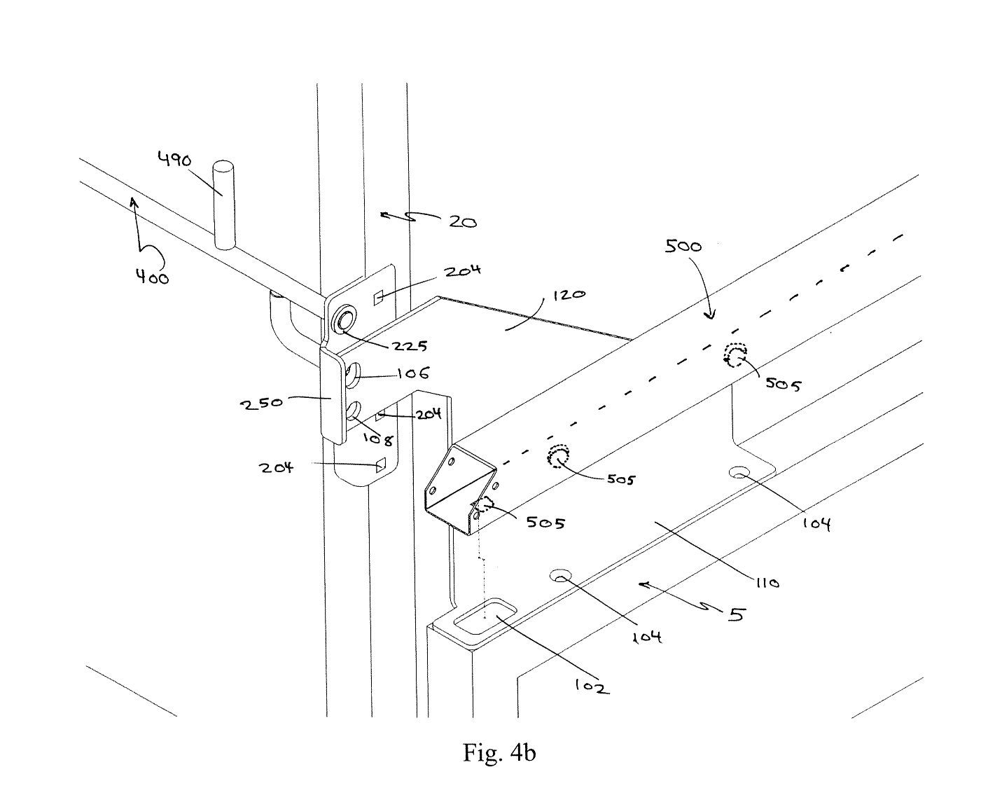

Referring to FIGS. 3a and 4b, the rack brackets 100, 120 include tailgate assist slots 102, mounting holes 104, rod slots 106, rack locking holes 108, and mounting flanges 110.

Referring to FIGS. 3b, 4a and 4b, the gate brackets 200, 240 include mounting holes 204, rod holes 220, flange locking holes 230, and rod bushings 225. As desired, one or more gate brackets 200, 240 include a stop flange 250. In some embodiments, the second gate bracket 240 includes a stop flange 250. Mounting holes 204 are generally square in configuration in order to receive a mating portion of a carriage bolt used in securing the gate brackets 200, 240 to the lift gate 20.

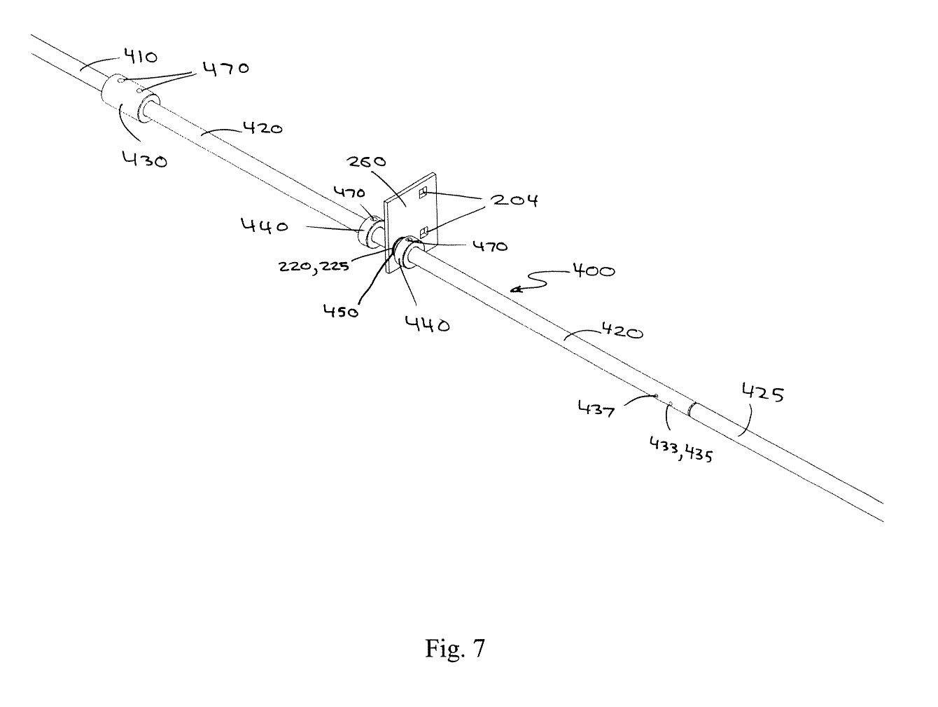

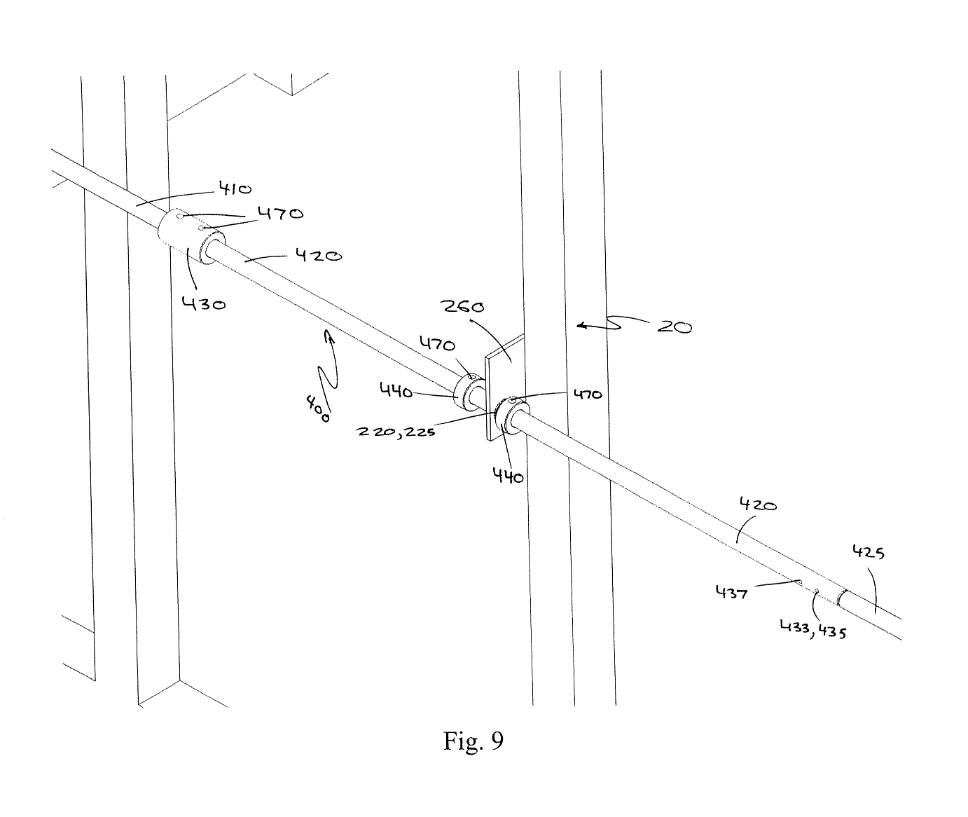

As shown in FIGS. 7 and 9, a rod bracket 260 having mounting holes 204, a rod hole 220 formed therein, and a rod bushing 225 is provided and affixed to the lift gate 20 (see FIG. 9). Mounting holes 204 are generally square in configuration in order to receive a mating portion of a carriage bolt used in securing the rod bracket 260 to the lift gate 20.

As shown in FIGS. 2, 3a, 3b, 4a, 4b, 5 and 7, the rod assembly 400 includes a first rod 410, a second rod 420, a barrel coupling 430, one or more shaft collars 440, one or more springs 450, rod ends 480 and one or more handles 490. Set screws 470 are affixed to recesses 475 formed in each of the barrel coupling 430 and the shaft collar 440 in order to adjustably affix barrel couplings 430 and shaft collars 440 upon the rod assembly 400.

Referring to the several Figs., in operation, the system 10 for securing lift gate 20 allows an operator to open and close a lift gate 20 from a single position. The one or more springs 450 are adjustably mounted to the rod assembly 400 in relation to the gate brackets 200, 240, the rack brackets 100, 120 and the rod bracket 260 in order to maintain directional force on the rod assembly 400. By selecting where along the rod assembly 400 to secure shaft collars 440, an operator may adjust the amount of spring 450 force as desired. By way of further example, alternative embodiments provide another spring 450 mounted on the second rod 420 to the right side, in reference to but hidden in FIG. 7 due to the spring 450 being in a compressed state, for embodiments where present, and proximal to rod bracket 260 and secured in place by shaft collar 440. Provision of such a second spring 450 allows for additional spring 450 force as desired on alternative embodiments. There is no need for an operator to walk to the other side of the trailer 5 to secure the lift gate 20 on that other side as both sides are secured at the same time. Alternative embodiments include the use of a securing means, such as, for example, a lock (not shown), a portion of which is passed through each of adjustably aligned rack locking holes 108 and flange locking holes 230, thereby providing an additional means of securing the lift gate 20 to the trailer 5.

Alternative embodiments allow for installation of the system 10 on trailers 5 of varying configuration with respect to the lift gate 20 and its position proximal to the trailer 5 when the lift gate 20 is at rest in a closed position. For example, some lift gates 20 come to rest in a closed position such that the sides of the lift gate 20 are just inside and in proximal contact to the sides of the trailer 5. In other embodiments, the outermost extremity of the lift gate 20 comes into direct contact with the back ends of the trailer sides and such contact prevents the lift gate 20 from further movement past its closed position. Embodiments of the system 10 accommodate such differences in lift gates 20 by selecting and appropriately aligning the rack brackets 100, 120. The rack brackets 100, 120 may be selectably mounted in one or more orientations, such as, for example, with their mounting flanges 110 aligned inwards, towards the center of the trailer 20 or alternatively; with their mounting flanges 110 aligned outwards, away from the center of the trailer 20, or for embodiments where more than one of either a first or second rack bracket 100, 120 is provided to a user for installation and use; with both mounting flanges 110 aligned in the same direction, such as, for example, with both mounting flanges 110 aligned to either the right or the left as viewed from the position of an observer located behind the trailer 5.

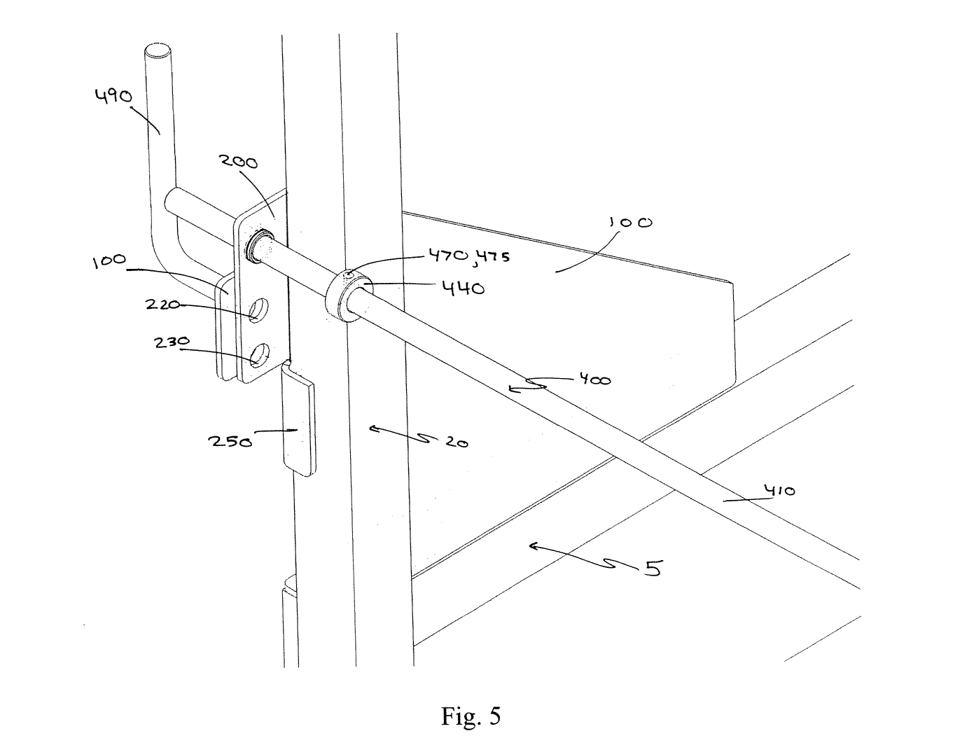

As shown in FIG. 5, embodiments include tailgate assist slots 102 in the rack brackets 100, 120 adjustably aligned with openings such as, for example, mating orifices 505 used to mount an existing tailgate assist device 500 such as, for example, a “Gorilla Lift”® (brand device or another device. By virtue of a slot configuration, the mounting flanges 110 in such embodiments allow the tailgate assist device 500 to be affixed as desired with relative adjustment fore and aft, in relation to the rack brackets 100, 120 and the trailer 20 itself. While the details of such a tailgate assist device 500 are not recited in the present teachings, it will be understood by those skilled in the art that it is within their capability to provide such a tailgate assist device in the necessary configuration as to be mounted and operate in conjunction with the system and method of the multiple embodiments contemplated herein.

As shown in FIGS. 2, 6, 7 and 9, embodiments may include one or more rods joined together by joining means such as, for example, a rod having a reduced diameter at one end inserted into a mating orifice of an adjacent rod, or rods joined with barrel couplings. Embodiments include those where a third rod 425 having a reduced diameter (hidden) at one end with that end inserted into a mating orifice (hidden) provided in the second rod 420. Alternatively, all the rods are joined in this manner, or two or more barrel couplings 430 may be utilized in order to secure three or more rods. In cases of reduced-diameter rod embodiments, for example, the third and second rods 425, 420, respectively, are secured one to the other by securing means such as, for example, a roll pin 433 inserted through pin orifice 435, passing through a mating rod orifice (hidden) formed in third rod 425 thereby securing the second and third rods 420, 425 together. Alternative securing means include rivets, bolts, screws and the like. A drain hole 437 is provided as illustrated in FIG. 7 in order to facilitate plating during manufacture of the assembly 10.

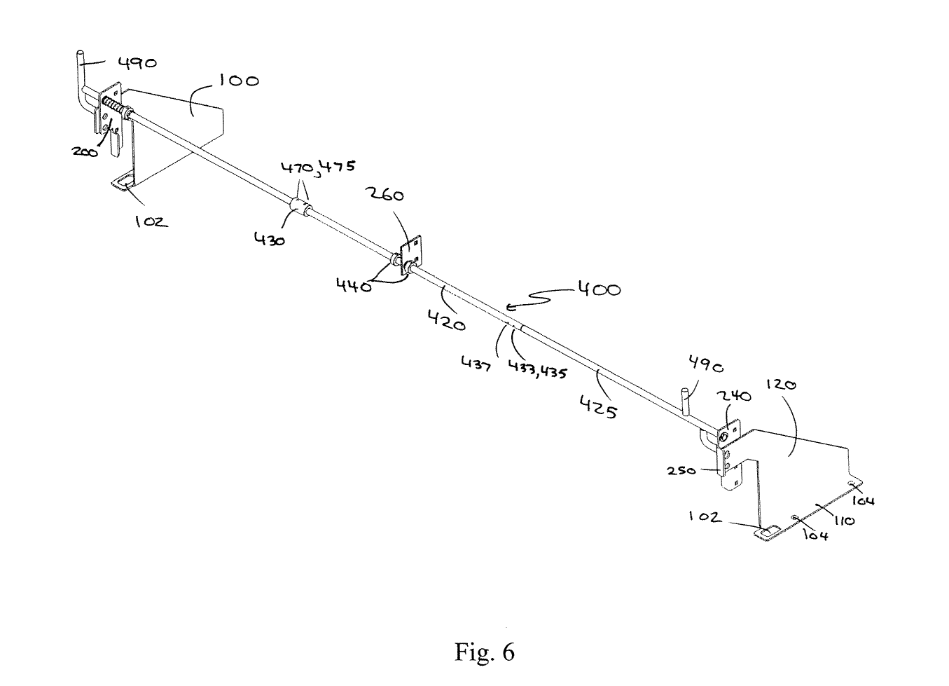

Embodiments provide one or more handles 490 that are formed generally at either or both ends, as desired and as shown in FIG. 6, of the rod assembly 400. For example, the handle 490 may be formed on both the first rod 410 and the second rod 420, thereby allowing an operator to operate the system 10 from either side of the trailer 5. Alternatively, a handle 490 may be formed on the first rod 410 and the third rod 425 in those embodiments having three rods. Alternatively, and as desired, additional handles 490 are formed on intermediate rods such as, for example, the second rod 420 of a three-rod system 10.

Further embodiments include forming a chamfer 485 on the rod ends 480 in order to ease alignment of the rod assembly 400 with and into the mating rod slots 106 in the gate brackets 200, 240 thereby allowing the closing and securing of the lift gate 20 with only a single instance of force being applied by an operator to initiate the closing and securing of the lift gate 20.

The stop flange 250 is provided in one embodiment on the second gate bracket 240, or alternatively on the first gate bracket 200 or even on both gate brackets 200, 240, in order to arrest further movement of the lift gate 20 as the stop flange 250 comes into contact with, and further motion is arrested by, structure on the trailer such as, for example, the second rack bracket 120 as shown in FIG. 4a and thereby allowing closing and snap-in securing of the lift gate 20 without risk of the lift gate 20 moving past a secured position. Depending on the trailer 5 configuration, alternative embodiments provide that the stop flange 250 contact a portion of the trailer 5 itself, separate and apart from the lift gate 20 and the system 10.

Although the embodiments in the Figs. show a lift gate 20 affixed to a trailer 5 and oriented to rotate downwards from a vertical position when closed, to a substantially horizontal position when open; the present system and method provides other embodiments having orientations wherein the lift gate 20 rotates upwards from a vertical position when closed, to a substantially horizontal position when open; and yet more orientations wherein the motions are substantially sideways and, accordingly, the lift gate is secured by hinges (not shown) that are aligned vertically. Additionally, a system 10 may include two or more lift gates 20, such as, for example, a left and right, or a top and bottom, lift gate 20 that meet to form a closed position.

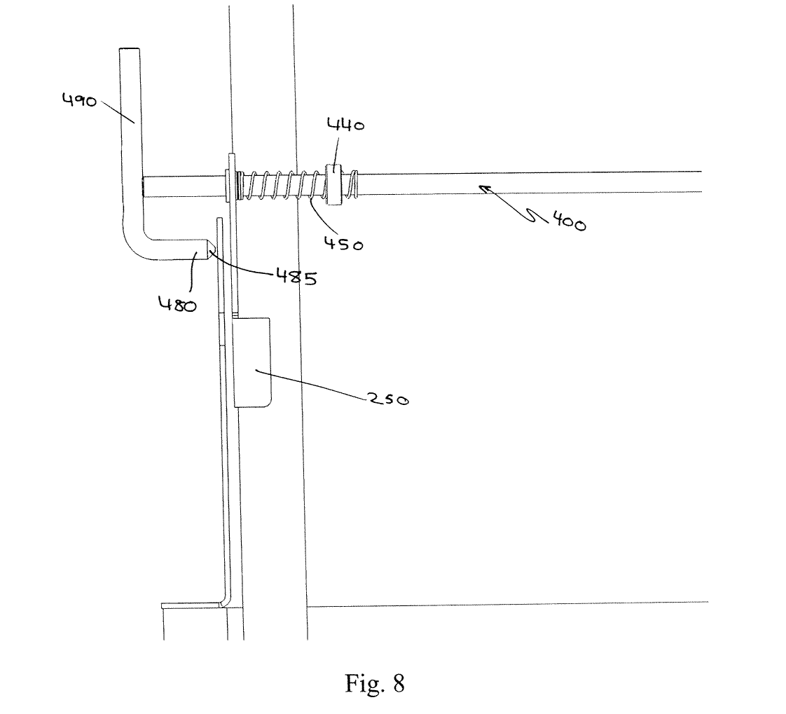

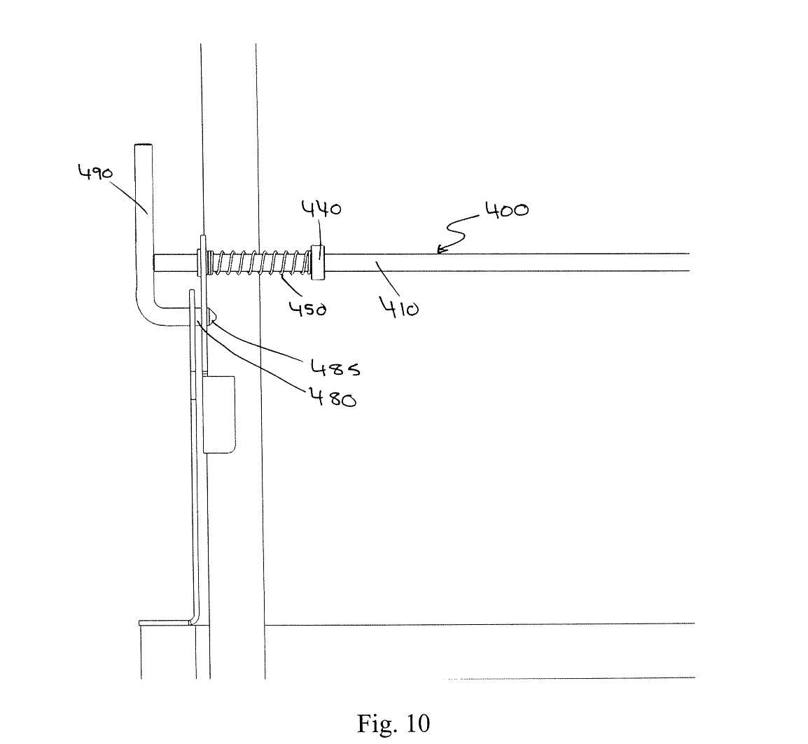

Referring to FIGS. 6, 8, 9 and 10 and whether or not the system 10 includes chamfers 485, a method for securing lift gate comprises the following steps:

Grasping a lift gate 20,

Applying force to the lift gate 20 sufficient to move the lift gate 20 towards its closed position,

Applying force to a handle 490 sufficient to compress one or more springs 450 thereby moving rod ends 480 and moving a rod assembly 400 within rod holes 220,

Continuing the application of force to the lift gate 20 thereby allowing the rod ends 480 to align with rod slots 106,

Releasing the handle 490 thereby allowing the one or more springs 450 to extend and force insertion of the rod ends 480 into the rod slots 106 and securing the lift gate 20 in a closed position,

In opening the lift gate 20, applying force to the handle 490 sufficient to compress the one or more springs 450 thereby moving the rod ends 480 and moving the rod assembly 400 within the rod holes 220 and withdrawing the rod ends 480 from the rod slots 106,

Applying force to the lift gate 20 thereby moving the lift gate 20 towards its open position.

For embodiments and alternatives where the system 10 includes chamfers 485, the user may, as desired, reduce the steps to the following:

Grasping a lift gate 20;

Applying force to the lift gate 20 sufficient to move the lift gate 20 towards its closed position and, as chamfers 485 of rod ends 480 engage rack brackets 100, 120, sufficient to compress one or more springs 450 thereby moving the rod ends 480, moving a rod assembly 400 within rod holes 220, thereby allowing the rod ends 480 to align with the rod slots 106, thereby allowing the one or more springs 450 to extend and force insertion of the rod ends 480 into the rod slots 106 and securing the lift gate 20 in a closed position;

In opening the lift gate 20, applying force to the handle 490 sufficient to compress the one or more springs 450 thereby moving the rod ends 480 and moving the rod assembly 400 within the rod holes 220 and withdrawing the rod ends 480 from the rod slots 106,

Applying force to the lift gate 20 thereby moving the lift gate 20 towards its open position.

It will therefore be readily understood by those persons skilled in the art that the present embodiments are susceptible of a broad utility and application. While the present embodiments are described in all currently foreseeable alternatives, there may be other, unforeseeable embodiments, alternatives, and adaptations, as well as variations, modifications and equivalent arrangements that do not depart from the substance or scope of the present embodiments and alternatives. The foregoing disclosure is not intended or to be construed to limit or otherwise to exclude such other embodiments, alternatives, adaptations, variations, modifications and equivalent arrangements, the present embodiments being limited only by the claims appended hereto and the equivalents thereof.

I claim:

1. A system for securing lift gate comprising:
One or more rack brackets including tailgate assist slots;
a first gate bracket;
a second gate bracket;
a rod bracket; and,
a rod assembly.

2. The system for securing lift gate of claim 1 rack brackets including a first rack bracket and a second rack bracket wherein the rack brackets include mounting holes, rod slots, rack locking holes, and mounting flanges.

3. The system for securing lift gate of claim 2 gate brackets including mounting holes, rod holes, flange locking holes, and indexing orifices.

4. The system for securing lift gate of claim 3 one or more gate brackets including a stop flange.

5. The system for securing lift gate of claim 3 second gate bracket including a stop flange.

6. The system for securing lift gate of claim 4 rod bracket having mounting holes and a rod hole formed therein and affixed to the lift gate.

7. The system for securing lift gate of claim 6 rod assembly including one or more rods, a barrel coupling, one or more shaft collars, one or more springs, rod ends, and one or more handles.

8. The system for securing lift gate of claim 7 rod assembly including a first rod and a second rod.

9. The system for securing lift gate of claim 8 rod ends having a chamfer formed thereupon.

10. The system for securing lift gate of claim 9 one or more springs adjustably mounted to the rod assembly in relation to the gate brackets, rod bracket and the rack brackets.

11. The system for securing lift gate of claim 10 set screws affixed to recesses formed in each of the barrel coupling and the shaft collars.

12. The system for securing lift gate of claim 11 securing means passed through each of adjustably aligned rack locking holes and flange locking holes.

13. The system for securing lift gate of claim 12 rack brackets selectably mounted in one or more orientations selected from the group mounting flanges aligned inward, mounting flanges aligned outward, or both mounting flanges aligned in same direction.

14. The system for securing lift gate of claim 13 a tailgate assist device affixed upon the mounting flanges thereby selectably aligning the mating orifices in the tailgate assist device with the tailgate assist slots of the rack brackets.

15. The system for securing lift gate of claim 13 rod assembly having a handle formed on both of the first rod and the second rod.

16. The system for securing lift gate of claim 13 rod assembly including two or more rods joined together by joining means selected from the group rod having a reduced diameter at one end inserted into a mating orifice of an adjacent rod, rods joined with barrel couplings.

17. The system for securing lift gate of claim 16 rod assembly including a third rod secured to a second rod with securing means selected from the group roll pin, rivet, bolt and screw.

18. The system for securing lift gate of claim 16 rod assembly including the third rod secured to the second rod with a roll pin.

19. The system for securing lift gate of claim 16 rod assembly including two or more barrel couplings to secure three or more rods.

20. A method for securing lift gate comprising the steps of:
Grasping a lift gate;
Applying force to the lift gate sufficient to move the lift gate towards its closed position;
Applying force to a handle sufficient to compress one or more springs thereby moving rod ends and moving a rod assembly within rod holes;
Continue applying force to the lift gate thereby allowing the rod ends to align with rod slots;
Releasing the handle thereby allowing the one or more springs to extend and force insertion of the rod ends into the rod slots and securing the lift gate in a closed position;
In opening the lift gate, applying force to the handle sufficient to compress the one or more springs thereby moving the rod ends and moving the rod assembly within the rod holes and withdrawing the rod ends from the rod slots; and,
Applying force to the lift gate thereby moving the lift gate towards its open position.

21. A method for securing lift gate comprising the steps of:
Grasping a lift gate;
Applying force to the lift gate sufficient to move the lift gate towards its closed position and, as chamfers of rod ends engage rack brackets, sufficient to compress one or more springs thereby moving the rod ends, moving a rod assembly within rod holes, thereby allowing the rod ends to align with the rod slots, thereby allowing the one or more springs to extend and force insertion of the rod ends into the rod slots;
And securing the lift gate in a closed position;
In opening the lift gate, applying force to a handle sufficient to compress the one or more springs thereby moving the rod ends and moving the rod assembly within the rod holes and withdrawing the rod ends from the rod slots; and,
Applying force to the lift gate thereby moving the lift gate towards its open position.
